(19) United States
(12) Patent Application Publication
(10) Pub. No.: US 2006/0236133 A1
(43) Pub. Date: Oct. 19, 2006

(54) Computer host with a secondary panel

(76) Inventor: Chia-Chin Wang, Taipei (TW)

Correspondence Address: LOWE HAUPTMAN BERNER, LLP, 1700 DIAGONAL ROAD, SUITE 300, ALEXANDRIA, VA, 22314, US

(21) Appl. No.: 11/106,583

(22) Filed: Apr. 15, 2005

(51) Int. Cl. G06F 1/00; G06F 3/00

(52) U.S. Cl. 713/300; 710/15

(57) ABSTRACT

A computer host is mounted with a secondary panel. When power for the computer host is turned on, multimedia data are accessed from a disk drive, a hard disk driver, or a memory card reader etc. and output by a media player program, without needing to activate an operating system of the computer host. Video and image files are directly displayed on the secondary panel. Even when the power for the computer host is not activated, multimedia data stored in memory cards still can be accessed and then represented on the secondary panel.

### BACKGROUND OF THE INVENTION

1. Field of the Invention

The invention relates to a computer host, more particularly to a computer host having a secondary panel where even when an operating system (OS) of the computer is not activated, video/audio data such as WMA, MP3 or JPEG files still can be displayed/played on the secondary panel or through a speaker.

2. Related Art

For most personal computers, an operating system (OS) is the required software that serves as a platform to integrate different peripheral devices and application programs so that users can easily utilize these resources. For instance, a series of different versions operating systems Windows™ operating systems developed by Microsoft™ Company have became the most famous OS and been widely applied in personal computers as well as notebooks computers.

As well known by most computer users, to activate the operating system is the essential procedure before using any hardware/software. However, in some situations that users may just want to execute some simple operations such as reading memory cards, playing audio files or reviewing pictures, the users still need to boot the computer, execute the operating system and execute particular programs so as to access desired information. Such booting procedures for users who just require simple operation appear redundant and unnecessary.

For the above reasons, there is a need for a novel computer system that allows users to acquire video/audio information without needing to boot the computer.

### SUMMARY OF THE INVENTION

An objective of the present invention is to provide a computer host with a secondary panel, wherein even when an operating system of the computer host is not loaded, multimedia data including video, audio or image files can be accessed and then represented on the secondary panel.

To accomplish the objective, the computer host comprises:

a mainboard connected to a secondary panel, a speaker and a power supply;

a first plurality of peripheral devices connected to the mainboard and the power supply, the first plurality of peripheral devices receiving operating voltage from the power supply only when the computer host enters a power-on mode thus allowing multimedia data accessed from the first plurality of peripheral devices to be output by a media player program without needing to load an operating system of the computer host; and

a second plurality of peripheral devices connected to the mainboard and the power supply, the second plurality of peripheral devices receiving operating voltage from the power supply when the computer host enters either the power-on mode or a power off mode, wherein multimedia data accessed from the secondary plurality of peripheral devices are processed by a media decoder and then output to the secondary panel or the speaker.

Further advantages, features and details of the present invention will be elucidated on the basis of the following description of a preferred embodiment thereof, with reference to the annexed figure showing a circuit diagram thereof.

### BRIEF DESCRIPTION OF THE DRAWINGS

FIG. 1 is a circuit block diagram of the computer host in accordance with the present invention.

FIG. 2 is a perspective view of a computer host with a secondary panel in accordance with the present invention.

FIG. 3 is another perspective view of the computer host in accordance with the present invention where the secondary panel is moved upward to show connecting ports.

FIG. 4 is yet another perspective view of the computer host in accordance with the present invention where the secondary panel is moved downward to show a disc driver.

### DETAILED DESCRIPTION OF THE PREFERRED EMBODIMENT

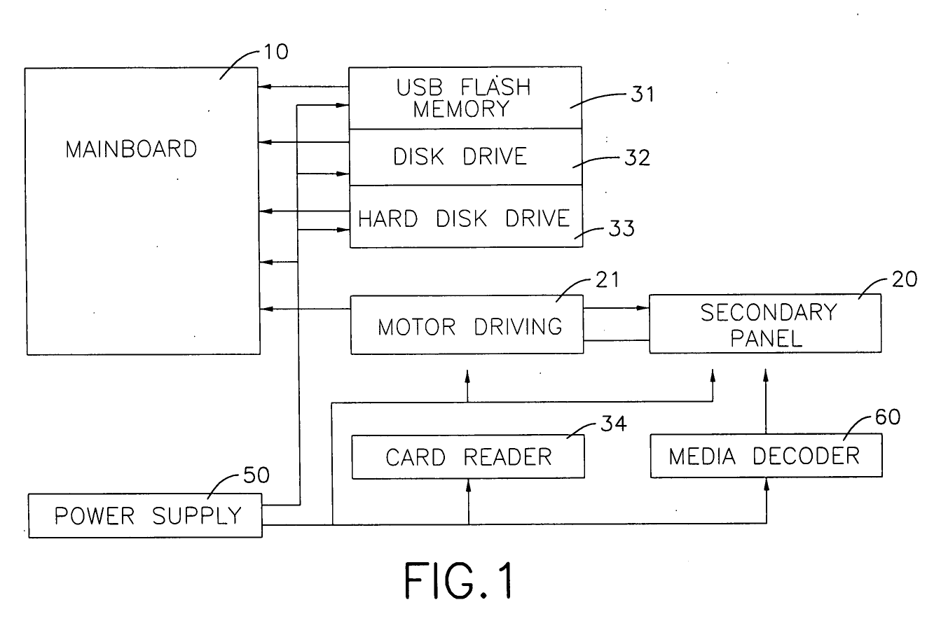

With reference to FIG. 1, a computer host in accordance with the present invention has a mainboard (10), and a secondary panel (20) connected to the mainboard (10) through a motor driving mechanism (21). The mainboard (10) can further connect to other devices including a detachable USB flash memory (31), a disk drive (32), a hard disk drive (33), a card reader (34) etc. A power supply (50) provides DC operating voltages to the above mentioned devices. The mainboard (10) has two video signal ports to respectively connect to a main display device (not shown) and the secondary panel (20). Since the main display device can be any kind of well known types and is not the feature of the present invention, the main display device is omitted from the drawing.

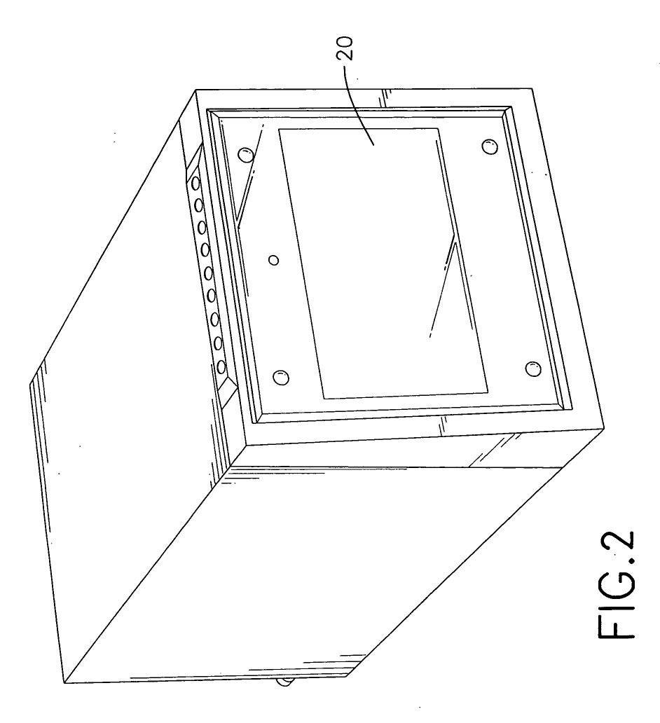

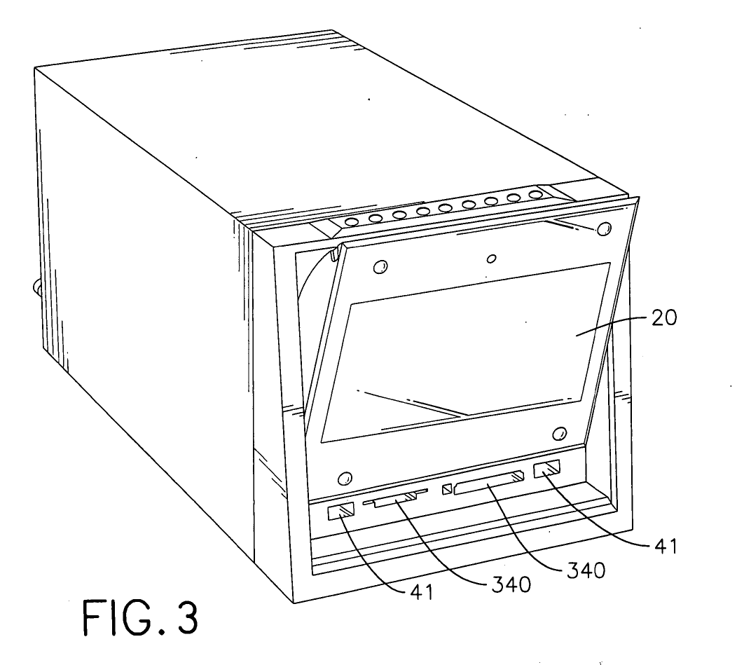

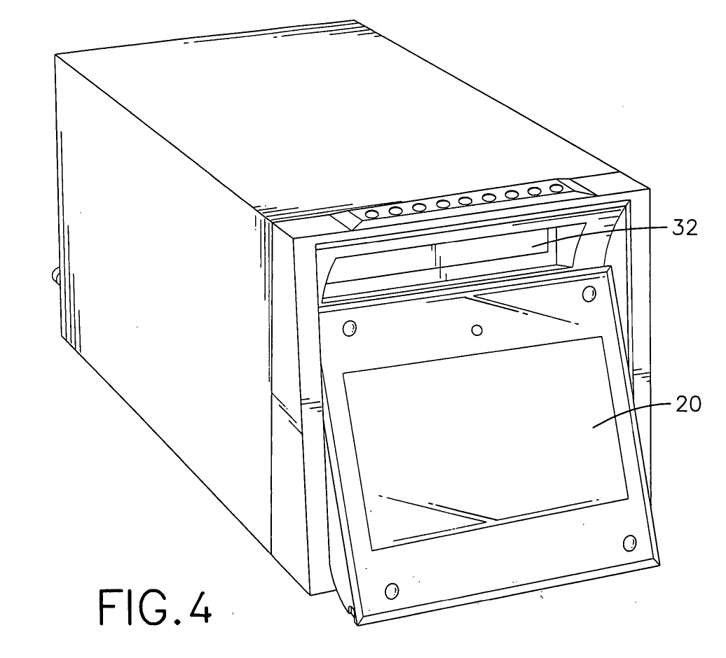

With reference to FIGS. 2 to 4, the computer host has a case and the mainboard (10) is mounted inside. The secondary panel (20) is movably attached on a front surface of the case. Multiple interface ports including USB ports (41), and memory card slots (340) of the card reader (34) are all formed on a lower position of the case. The disk drive (32) is also secured in the case and installed in an upper position above the interface ports. Based on the control of the motor driving mechanism (21), the secondary panel (20) can completely cover the interface ports and the disk drive (32) as shown in FIG. 2. Otherwise, the secondary panel (20) can be driven to slide upward or downward so that either the interface ports or the disk drive (32) is revealed.

According to whether the power of the computer host is turned on or not, i.e. whether the power button is pressed, the computer host of the present invention has two different operating modes. In the “power-on” mode, the power supply (50) provides operating voltages to the mainboard (10), the disk drive (32), the hard disk drive (33) the motor driving mechanism (21), the secondary panel (20) and the card reader (34). In this mode, the USB flash memory (32) is connected to one USB port (41) of the computer host. Some driving programs and a media player are recorded in the USB flash memory (32). When the power supply (50) is activated, audio, video, or IDE chip sets etc. that are mounted on the mainboard (10) can be successfully activated by these driving programs in the USB flash memory (32). Furthermore, without needing to load the operating system like the Windows™, multimedia data can be directly displayed via the media player program. The types of multimedia data can include, but are not limited to, audio, video or image files stored in an optical disk, a memory card or the hard disk drive (33). Any optical disk or memory card that has been inserted into the slot (340) can be accessed by the disk drive (33) or the card reader (34). The secondary panel (20) displays the video or image files, and the audio files are broadcast via a speaker.

With reference to FIG. 1, the other operating mode is a “power-off” mode. Even when the power button is not pressed, the power supply unit (50) still provides operating voltages to the motor driving mechanism (21), the secondary panel (20), the card reader and a media decoder (60). In this mode, only the multimedia data stored in the memory cards can be accessed via the card reader (34), where the multimedia data are processed by the media decoder (60) and then output to either the secondary panel (20) or the speaker.

The present invention is not however limited to the above described preferred embodiment thereof; the rights sought are defined by the following claims, within the scope of which many modifications can be envisaged.

What is claimed is:

1. A computer host with a secondary panel, the computer host comprising:
a mainboard connected to a secondary panel, a speaker and a power supply;
a first plurality of peripheral devices connected to the mainboard and the power supply, the first plurality of peripheral devices receiving operating voltage from the power supply only when the computer host enters a power-on mode thus allowing multimedia data accessed from the first plurality of peripheral devices to be output by a media player program without needing to load an operating system of the computer host; and
a second plurality of peripheral devices connected to the mainboard and the power supply, the second plurality of peripheral devices receiving operating voltage from the power supply when the computer host enters either the power-on mode or a power off mode, wherein multimedia data accessed from the secondary plurality of peripheral devices are processed by a media decoder and then output to the secondary panel or the speaker.

2. The computer host as claimed in claim 1, the first plurality of peripheral devices comprises:
a detachable USB flash memory storing a media player program and driving programs for video, audio or IDE chip sets of the mainboard;
a disk drive provided to access the multimedia data stored in an optical disk; and
a hard disk drive storing the multimedia data.

3. The computer host as claimed in claim 1, the second plurality of peripheral devices comprises a card reader to access the multimedia data stored in memory cards.

4. The computer host as claimed in claim 2, the second plurality of peripheral devices comprises a card reader to access the multimedia data stored in memory cards.

5. The computer host as claimed in 2, wherein the computer host further has a case to retain the mainboard and the disk drive, multiple interface ports including USB ports and memory card slots of the card reader are formed on a front surface of the case, and the secondary panel is movably attached on the front surface of the case.

6. The computer host as claimed in 4, wherein the computer host further has a case to retain the mainboard and the disk drive, multiple interface ports including USB ports and memory card slots of the card reader are formed on a front surface of the case, and the secondary panel is movably attached on the front surface of the case.
